(19) United States
(12) Patent Application Publication
(10) Pub. No.: US 2021/0114361 A1
(43) Pub. Date: Apr. 22, 2021

(54) EXTRUDED POLYURETHANE SURFACE FILMS

(71) Applicant: 3M INNOVATIVE PROPERTIES COMPANY, St. Paul, MN (US)

(72) Inventors: Charlie Chia-Tie HO, Woodbury, MN (US); Yongshang LU, Woodbury, MN (US); John J. JAROS, Lake Elmo, MN (US); Jay M. JENNEN, Forest Lake, MN (US); Ryan M. BRAUN, St. Paul, MN (US); Sean P. ADDISON, Athens, AL (US); Trevor A. LARSON, Madison, AL (US); Richard J. POKORNY, Maplewood, MN (US); Joan M. NOYOLA, Maplewood, MN (US); Zachary J. MALMBERG, Roseville, MN (US); Thomas P. KLUN, Lakeland, MN (US); Moses M. DAVID, Wells, TX (US); Jun MA, Woodbury, MN (US); Cordell M. HARDY, Woodbury, MN (US)

(21) Appl. No.: 17/058,049

(22) PCT Filed: Aug. 6, 2019
(86) PCT No.: PCT/IB2019/056690

§ 371 Date: Nov. 23, 2020

Related U.S. Application Data
(60) Provisional application No. 62/718,689, filed on Aug. 14, 2018.

(51) Int. Cl. B32B 27/40; B32B 27/08; B32B 7/12; B32B 27/14; B32B 37/15; C08G 18/12; C08G 18/32; C08G 18/42; C08G 18/66; C08G 18/75; C08G 18/76

(52) U.S. Cl. CPC B32B 27/40; B32B 2605/08; B32B 7/12; B32B 27/14; B32B 37/153; C08G 18/12; C08G 18/3206; C08G 18/4213; C08G 18/4238; C08G 18/4283; C08G 18/664; C08G 18/755; C08G 18/7621; C08G 18/7628; B32B 2250/03; B32B 2264/1021; B32B 2307/536; B32B 2333/04; B32B 2375/00; B32B 2405/00; B32B 27/08

(57) ABSTRACT

Various embodiments disclosed relate to a surfacing film. The surfacing film includes a base layer. The base layer includes a thermoplastic polyurethane film comprising a reaction product of a reaction mixture of a diisocyanate, a polyester polyol having a melting temperature of at least about 30° C.; and a diol chain extender. There are many reasons to use the surfacing film including easier and more cost effective manufacturing of the surfacing film by directly extruding the base layer by mixing the reaction mixture in an extruder. Another reason to use the surfacing film is that the film has improved resistance to discoloration. Another reason to use the film is that the film shows good toughness.

### BACKGROUND

Multilayer films can include one or more layers of a polyurethane material. Some of these films can be used in surface protection applications. For example, multilayer film products can be used to protect the painted surface of selected automobile body parts.

### SUMMARY OF THE DISCLOSURE

The present disclosure provides a surfacing film. The surfacing film includes a base layer. The base layer includes a thermoplastic polyurethane film comprising a reaction product of a reaction mixture of a diisocyanate, a polyester polyol having a melting temperature of at least about 30° C.; and a diol chain extender.

The present disclosure further provides a method of making a surfacing film. The method includes forming a base layer. Forming the base layer includes introducing components comprising a diisocyanate, a diol chain extender, and a polyester polyol into an extruder to provide a molten thermoplastic polyurethane, wherein the polyester polyol has a melting temperature of at least 30° C. The method further includes extruding the molten thermoplastic polyurethane through a die onto a carrier web as a uniform film. The method further includes solidifying the thermoplastic polyurethane film to obtain the base layer.

There are various reasons to use the surfacing film of the present disclosure including the following non-limiting reasons. For example, the thermoplastic polyurethane can be formed directly by mixing and reacting the components of the thermoplastic polyurethane in an extruder, which can extrude the thermoplastic polyurethane as a film. This can substantially eliminate the need to form the thermoplastic polyurethane, pelletize the thermoplastic polyurethane, and deposit the pellets into an extruder. This can result in saving costs and time in producing the film.

Additionally, according to some examples, it is possible for the provided thermoplastic polyurethane film to have a higher molecular weight than those that are formed from extruding a film from pelletized polyurethanes. This is because thermoplastic polyurethanes that are pelletized are formed by extruding a polyurethane that is repeatedly cut to form smaller pellets having shortened thermoplastic polyurethane chains, which in turn form lower weight average molecular weight polyurethane films. This cutting to form pellets can result in the thermoplastic polyurethanes films having shorter chains and lower molecular weights than the thermoplastic polyurethanes films of the instant disclosure. According to some examples, the higher molecular weight of the thermoplastic polyurethane film can help to prevent color staining in the polyurethane film by making it more difficult for discoloring agents to penetrate the polyurethane.

Additionally, according to some examples, the reactive mixture includes a chain extender that has a weight-average molecular weight of less than 250 daltons. This can help to strengthen the thermoplastic polyurethane film. For example, the Shore A hardness of the thermoplastic polyurethane film can be larger than a corresponding thermoplastic polyurethane film including a chain extender with a weight-average molecular weight exceeding 250 daltons.

Additionally, according to some examples, the polyester polyol in the reactive mixture forming the polyurethane has a melting temperature of at least 30° C. This can impart a high degree of crystallinity to the thermoplastic polyurethane film. The high degree of crystallinity can help to make the surface film easier to handle in that the thermoplastic polyurethane film is more likely to be substantially non-tacky under ambient conditions (e.g., 25° C. and 1 ATM), which can make it easier to roll the surface film prior to storage or application to a substrate.

### BRIEF DESCRIPTION OF THE FIGURES

The drawings illustrate generally, by way of example, but not by way of limitation, various embodiments discussed in the present document.

FIG. 1 is a sectional view of a surface film, in accordance with various embodiments.

FIG. 2 is a sectional view of another surface film, in accordance with various embodiments.

FIG. 3-4 are sectional views other surface films, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading can occur within or outside of that particular section. All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule in which one or more hydrogen atoms contained therein are replaced by one or more non-hydrogen atoms. Examples of substituents or functional groups that can be substituted include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=ΣMᵢnᵢ/Σnᵢ. The Mₙ can be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, gel permeation chromatography, and sedimentation velocity.

The term “melting temperature” refers to a temperature or range of temperatures at which a material changes state from a solid to a liquid at a pressure of 1 ATM. The melting temperature can be determined using differential scanning calorimetry, where the melting temperature is taken at the end of the endothermic peak measured therein.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

According to various examples of the present disclosure, a surfacing film or surface protection film includes a thermoplastic polyurethane film. The thermoplastic polyurethane film can include many suitable components. Examples of suitable components include a thermoplastic polyurethane that is a reaction product of a reaction mixture that includes a diisocyanate, a polyester polyol having a melting temperature of at least about 30° C., and a diol chain extender.

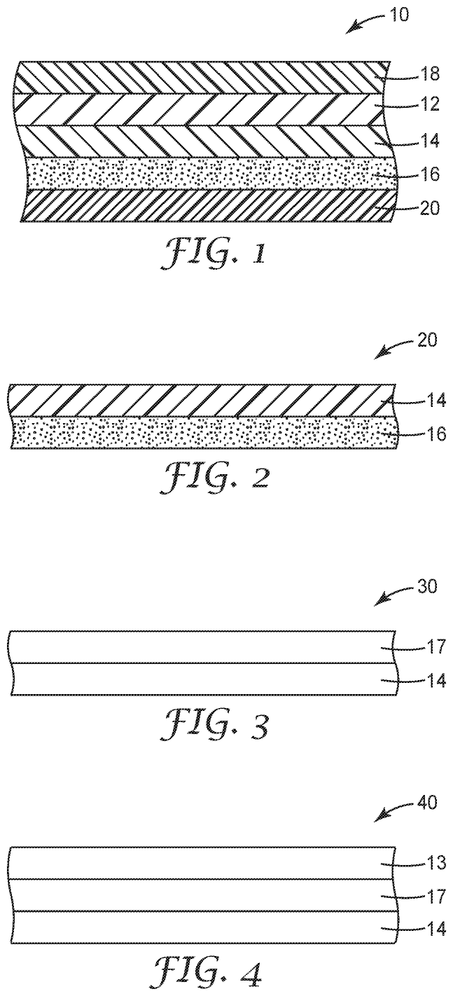

FIG. 1 is a sectional view of surfacing film 10, which includes a thermoplastic polyurethane film. As shown, surfacing film 10 includes optional thermosetting polyurethane or clear coat layer 12, transparent thermoplastic polyurethane film or base layer 14 and optional pressure-sensitive adhesive layer 16. An optional releasable carrier web or liner 18 can be releasably bonded to polyurethane layer 12 along its major surface facing away from the base layer 14 so as to protect the surface of thermosetting polyurethane layer 12. If the thermosetting polyurethane layer 12 is not present, the liner 18 can be releasably bonded to base layer 14 along its major surface facing away from pressure-sensitive adhesive layer 16 to protect the base layer 14. If pressure-sensitive adhesive layer 16 is present, it can be desirable for surfacing film 10 to also include another release liner 20 releasably bonded thereto as shown so as to protect pressure-sensitive adhesive layer 16. In some examples of surfacing film 10, all of these components are not present. FIG. 2 is a sectional view of another surfacing film 20 that only includes base layer 14 and pressure-sensitive adhesive layer 16. FIG. 3 is a sectional view of another surfacing film 10, that includes a thermoplastic polyurethane film base layer 14 and hardcoat layer 17. FIG. 4 is a sectional view of another surfacing film 10, that includes a thermoplastic polyurethane film base layer 14, hardcoat layer 17, and siliceous layer 13.

The thermoplastic polyurethane film can have a weight-average molecular weight in a range of from about 80,000 daltons to about 400,000 daltons, about 80,000 daltons to about 200,000 daltons, or equal to, less than, or greater than about, 80,000 daltons; 85,000; 90,000; 95,000; 100,000; 105,000; 110,000; 115,000; 120,000; 125,000; 130,000; 135,000; 140,000; 145,000; 150,000; 155,000; 160,000; 165,000; 170,000; 175,000; 180,000; 185,000; 190,000; 195,000; 200,000; 205,000; 210,000; 215,000; 220,000; 225,000; 230,000; 235,000; 240,000; 245,000; 250,000; 255,000; 260,000; 265,000; 270,000; 275,000; 280,000; 285,000; 290,000; 295,000; 300,000; 305,000; 310,000; 315,000; 320,000; 325,000; 330,000; 335,000; 340,000; 345,000; 350,000; 355,000; 360,000; 365,000; 370,000; 375,000; 380,000; 385,000; 390,000; 395,000; or 400,000 daltons. The high molecular weight of the thermoplastic polyurethane film can help to prevent discoloration of the film, at least in base layer 14. This is because the relatively high molecular weight of the thermoplastic polyurethane film can result from long chain length polyurethanes. The long chain length can result in base layer 14 being relatively tightly packed or highly entangled such that a discoloring compound cannot readily penetrate base layer 14 and cause discoloration therein. As an example, a yellowing color change of base layer 14 that is exposed to a 10% bitumen solution for 24 hours is less than that of a corresponding protection film comprising a base layer that includes a thermoplastic polyurethane film having a weight-average molecular weight of 80,000 daltons or less.

Base layer 14 can be sufficiently hard to withstand abrasion from foreign objects. As an example, a Shore A hardness of base layer 14 can be in a range of from about 70 A to about 95 A, about 83 A to about 90 A, or less than, equal to, or greater than about 70 A, 75 A, 76 A, 77 A, 78 A, 79 A, 80 A, 81 A, 82 A, 83 A, 84 A, 85 A, 86 A, 87 A, 88 A, 89 A, 90 A, 91 A, 92 A, 93 A, 94 A, or 95 A.

A thickness of base layer 14 can be in a range of from about 0.05 mm to about 2 mm, about 0.5 mm to about 1 mm, or less than, equal to, or greater than about 0.05 mm, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.6, 1.65, 1.7, 1.75, 1.8, 1.85, 1.9, 1.95, or 2 mm.

In some embodiments, base layer 14, is conformable. The conformability of film may be characterized by tensile testing, as determined by the test method described in the examples, utilizing a strain rate of 200%/min.

Conformable films generally have a lower tensile modulus in comparison to polyester (PET). For example, PET has a tensile modulus of at least 5000-6000 MPa; while conformable films typically have a tensile modulus less than 3000 MPa. In some embodiments, the tensile modulus of the conformable film is less than 1000, 750, 500, or 250 MPa. In some embodiments, the tensile modulus of the conformable film is less than 200, 150, or 100 MPa. The conformable film typically has a tensile modulus of at least 25, 30, 35, 40, 45, or 50 MPa.

Conformable films generally have a lower ultimate tensile strength in comparison to polyester (PET). For example, PET has an ultimate tensile strength of at least 150 MPa; while conformable films typically have an ultimate tensile strength less than 100 MPa. The conformable film typically has an ultimate tensile strength of at least 10, 15, or 20 MPa.

Conformable films generally have a higher tensile strain at break, or in other words a higher elongation at break in comparison to polyester (PET). For example, PET has a tensile strain at break of less than 100%; while conformable films typically have a tensile strain at break of at least 150, 175, or 200%. In some embodiments, the conformable film has a tensile strain at break of no greater than 500%, 400%, or 300%.

Conformable films generally have a lower load at 25% strain in comparison to polyester (PET). For example, PET has a load at 25% strain of at least 150 N/cm film width; while conformable films typically have a load at 25% strain of less than 50, 40, 30, 20, or 10 N/cm film width. In some embodiments, the conformable film has a load at 25% strain of at least 2, 3, 4, or 5 N/cm film width.

The load at 25% strain/cm film width is surmised important for stretching films by hand and/or applying films to objects by hand. If a film has too high of a load at desired strain (e.g. 25%), most people will not be able to stretch or apply such film by hand to an object due to the excessive force required to stretch the film. For example, a typical person can apply a 50N force by hand. This is sufficient force to stretch a 5 cm wide conformable film 25%. However, most people would not be able to stretch PET films by hand as this would require over 700 N of force to stretch a 5 cm wide film 25%

As mentioned herein, the thermoplastic polyurethane is a reaction product of a reaction mixture that includes a diisocyanate, a polyester polyol having a melting temperature of at least about 30° C., and a chain extender. The diisocyanate can range from about 0.5 wt % to about 40 wt % of the reaction mixture, about 1 wt % to about 10 wt %, about 25 wt % to about 47 wt %, or less than, equal to, or greater than about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, or 47 wt % of the reaction mixture. The amount of the diisocyanate in the reactive mixture can be expressed in terms of an isocyanate index. An isocyanate index can be generally understood to refer to the ratio of the equivalent amount of isocyanate functional groups used relative to the theoretical equivalent amount of hydroxy functional groups. The theoretical equivalent amount is equal to one equivalent isocyanate functional group per one equivalent hydroxyl group; this is an index of 100. According to various examples, the isocyanate index of the reactive mixture is in a range of from about 0.99 to about 1.20, about 1.00 to about 1.10, or less than equal to, or greater than about 0.99, 1.00, 1.01, 1.02, 1.03, 1.04, 1.05, 1.06, 1.07, 1.08, 1.09, 1.10, 1.11, 1.12, 1.13, 1.14, 1.15, 1.16, 1.17, 1.18, 1.19, or 1.20.

An example of a suitable diisocyanate includes a diisocyanate according to Formula I having the structure:

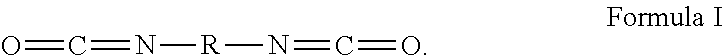

In Formula I, R is chosen from substituted or unsubstituted (C₁-C₄₀)alkylene, (C₂-C₄₀)alkenylene, (C₄-C₂₀)arylene, (C₄-C₂₀)arylene-(C₁-C₄₀)alkylene-(C₄-C₂₀)arylene, (C₄-C₂₀)cycloalkylene, and (C₄-C₂₀)aralkylene. In additional examples, the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate, methylenediphenylene-4,4′-diisocyanate, (4,4′-diisocyanato-3,3′,5,5′-tetraethyl) diphenylmethane, 4,4′-diisocyanato-3,3′-dimethoxybiphenyl (o-dianisidine diisocyanate), 5-chloro-2,4-toluene diisocyanate, 1-chloromethyl-2,4-diisocyanato benzene, tetramethyl-m-xylylene diisocyanate, 1,6-diisocyanatohexane 1,12-diisocyanatododecane, 2-methyl-1,5-diisocyanatopentane, methylenedicyclohexylene-4,4′-diisocyanate, 3-isocyanatomethyl-3,5,5-trimethylcyclohexyl isocyanate, 2,2,4-trimethylhexyl diisocyanate, or a mixture thereof.

The polyester polyol can be in a range of from about 43 wt % to about 70 wt % of the reaction mixture, about 50 wt % to about 60 wt %, or less than, equal to, or greater than about 43 wt %, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, or 70 wt % of the reaction mixture. The polyester polyol can include any suitable number of hydroxyl groups. For example, the polyester polyol can include four hydroxyl groups or three hydroxyl groups. The polyester polyol can even include two hydroxyl groups such that the polyester polyol is a polyester diol. In general, the polyester polyol can be a product of a condensation reaction such as a polycondensation reaction. However, the polyester polyol is not made via a ring opening polymerization reaction products.

In examples where polyester polyol is made according to a condensation reaction, the reaction can be between one or more carboxylic acids and one or more polyols. An example of a suitable carboxylic acid includes a carboxylic acid according to Formula II, having the structure:

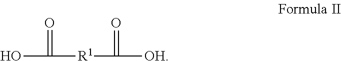

In Formula II, R¹ is chosen from substituted or unsubstituted (C₁-C₄₀)alkylene, (C₂-C₄₀)alkylene, (C₂-C₄₀)alkenylene, (C₄-C₂₀)arylene, (C₄-C₂₀)cycloalkylene, and (C₄-C₂₀) aralkylene. Specific examples of suitable carboxylic acids include glycolic acid (2-hydroxyethanoic acid), lactic acid (2-hydroxypropanoic acid), succinic acid (butanedioic acid), 3-hydoxybutanoic acid, 3-hydroxypentanoic acid, terepthalic acid (benzene-1,4-dicarboxylic acid), naphthalene dicarboxylic acid, 4-hydroxybenzoic acid, 6-hydroxynaphtalane-2-carboxylic acid, oxalic acid, malonic acid (propanedioic acid), adipic acid (hexanedioic acid), pimelic acid (heptanedioic acid), ethonic acid, suberic acid (octanedioic acid), azelaic acid (nonanedioic acid), sebacic acid (decanedioic acid), glutaric acid (pentanedioic acid), dedecandioic acid, brassylic acid, thapsic acid, maleic acid ((2Z)-but-2-enedioic acid), fumaric acid ((2E)-but-2-enedioic acid), glutaconic acid (pent-2-enedioic acid), 2-decenedioic acid, traumatic acid ((2E)-dodec-2-enedioic acid), muconic acid ((2E,4E)-hexa-2,4-dienedioic acid), glutinic acid, citraconic acid ((2Z)-2-methylbut-2-enedioic acid), mesaconic acid ((2E)-2-methyl-2-butenedioic acid), itaconic acid (2-methylidenebutanedioic acid), malic acid (2-hydroxybutanedioic acid), aspartic acid (2-aminobutanedioic acid), glutamic acid (2-aminopentanedioic acid), tartonic acid, tartaric acid (2,3-dihydroxybutanedioic acid), diaminopimelic acid ((2R,6S)-2,6-diaminoheptanedioic acid), saccharic acid ((2S,3S,4S,5R)-2,3,4,5-tetrahydroxyhexanedioic acid), mexooxalic acid, oxaloacetic acid (oxobutanedioic acid), acetonedicarboxylic acid (3-oxopentanedioic acid), arbinaric acid, phthalic acid (benzene-1,2-dicarboxylic acid), isophtalic acid, diphenic acid, 2,6-naphtalenedicarboxylic acid, or a mixture thereof.

An example of a suitable polyol includes a polyol according to Formula II, having the structure:

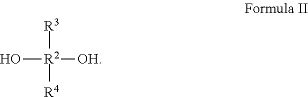

In Formula II, R² is chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene, and R³ and R⁴ are independently chosen from —H, —OH, substituted or unsubstituted (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy.

An example of another suitable polyol includes a polyol according to Formula III, having the structure:

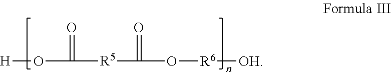

In Formula III, R⁵ and R⁶ are independently chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene and n is a positive integer greater than or equal to 1.

An example of another suitable polyol includes a polyol according to Formula IV, having the structure:

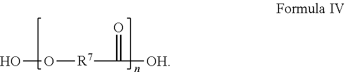

In Formula IV, R⁷ is chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene and n is a positive integer greater than or equal to 1. In specific examples, the polyester polyol includes one or more of polyglycolic acid (poly[oxy(1-oxo-1,2-ethanediyl)]), polybutylene succinate (poly(tetramethylene succinate)), poly(3-hydroxybutyrate-co-3-hydroxyvalerate), polyethylene terephthalate (poly(ethyl benzene-1,4-dicarboxylate)), polybutylene terephthalate (poly(oxy-1,4-butanediyloxycarbonyl-1,4-phenylenecarbonyl)), polytrimethylene terephthalate (poly(trimethylene terephthalate); poly(oxy-1,3-propanediyloxycarbonyl-1,4-phenylenecarbonyl)), polyethylene naphthalate (poly(ethylene 2,6-naphthalate)), poly(1,4-butylene adipate), poly(1,6-hexamethylene adipate), poly(ethylene-adipate), mixtures thereof, and copolymers thereof. However, the polyester polyol is free of polycaprolactone polyol ((1,7)-polyoxepan-2-one). The polyester polyol has a melting temperature of at least 30° C., at least 35° C., at least 40° C., at least 42° C., at least 45° C., at least 50° C., at least 55° C., at least 60° C., at least 65° C., at least 70° C., at least 75° C., at least 80° C., at least 85° C., at least 90° C., at least 95° C., at least 100° C., at least 110° C., at least 120° C., at least 130° C., at least 140° C., at least 150° C., at least 160° C., at least 170° C., at least 180° C., at least 190° C., at least 200° C., at least 210° C., at least 220° C., at least 230° C., at least 240° C., at least 250° C., at least 260° C., at least 270° C., at least 280° C., at least 290° C., at least 300° C., at least 310° C., at least 320° C., at least 330° C., at least 340° C., at least 350° C., at least 360° C., at least 370° C., at least 380° C., at least 390° C., at least 400, at least 410° C., at least 420° C., at least 430° C., at least 440° C., at least 450° C., at least 460° C., at least 470° C., at least 480° C., at least 490° C., or at least 500° C. Choosing an appropriate melting temperature can help to increase the degree of crystallinity of base layer 14. The degree of crystallinity can be determined through differential scanning calorimetry and is expressed as the fractional amount of crystallinity in the theremoplastic polyurethane film. The degree of crystallinity can be in a range of from about 30% to about 70%, about 40% to about 60%, or less than, equal to, or greater than, 30%, 35, 40, 45, 50, 55, 60, 65, or 70%. The degree of crystallinity can make it easier to roll base layer 14 as it takes a relatively high temperature to begin to liquefy base layer 14. Thus base layer 14 is less likely to stick to itself during rolling or storage. Examples of melting temperatures of some polyester polyols are provided herein at Table 1.

TABLE 1

| Polyester Polyol | Melting Temperature (° C.) |
|---|---|
| polyglycolic acid | 225 to 230 |
| polybutylene succinate | 115 |
| polyethylene terephthalate | 500 |
| polybutylene terephthalate | 433.4 |

The chain extender can be in a range of from about 2 wt % to about 13 wt % of the reaction mixture, about 1 wt % to about 10 wt %, or less than, equal to, or greater than about 2 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13 wt % of the reaction mixture.

The diol chain extender has weight-average molecular weight of less than about 250 daltons. For example a weight-average molecular weight of the diol chain extender can be in a range of from about 30 daltons to about 250 daltons, about 50 daltons to about 150 daltons, or less than equal to, or greater than about 30 daltons, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, or about 250 daltons. The diol chain extender can include any suitable number of carbons. For example, the diol chain extender can include a number-average number of about 2 carbons to about 20 carbons, about 3 carbons to about 10 carbons, or less than, equal to, or greater than about 2 carbons, 3, 4, 5, 6, 7, 8, 9, 10, 11, 12, 13, 14, 15, 16, 17, 18, 19, or 20 carbons. Diol chain extenders such as these can help to strengthen base layer 14. This can be because the relatively short chains can be stiffer than a longer chain diol. The short chain diols can be stiffer, for example, because the short chain diol is more restricted in terms of rotation about the individual bonds along the chain. Examples of suitable diol chain extenders include ethylene glycol, diethylene glycol, triethylene glycol, tetraethylene glycol, propylene glycol, dipropylene glycol, tripropylne glycol, 1,3-propanediol, 1,3-butanediol, 1,4-butanediol, neopentyl glycol, 1,6-hexanediol, 1,4-cyclohexanedimethanol, or a mixture thereof.

The thermoplastic polyurethane can include a hard segment. A hard segment generally refers to harder, less flexible polymer segment, which results from polymerization of the diisocyanate and the diol chain extender. The amount of the hard segment can be determined by calculating the total amount (wt %) of isocyanate, chain extender, and cross-linker. That total amount is then divided by the total weight of the thermoplastic polyurethane. The hard segment can be in a range of from about 30 wt % to about 55 wt % of the thermoplastic polyurethane film, about 40 wt % to about 55 wt %, or less than, equal to, or greater than about 30 wt %, 31, 32, 33, 34, 35, 36, 37, 38, 39, 40, 41, 42, 43, 44, 45, 46, 47, 48, 49, 50, 51, 52, 53, 54, or 55 wt % of the thermoplastic polyurethane film. Hard segments are present as domains, which can interact with each other to effectively form a crosslink therebetween (e.g., through a hydrogen bond). Under stress for example, through a mechanical deformation, the hard segments can become aligned in the stress direction. This alignment coupled with the hydrogen bonding can contribute to the stiffness, elastomeric resilience, or tear resistance of the thermoplastic polymeric film.

In some examples the reactive mixture can include a crosslinker. Examples of crosslinkers include polyhydroxy group compounds and polyisocyanate compound. For example, the polyhydroxy compounds can include 3 hydroxy groups or 4 hydroxy groups. The polyisocyanate can include 3 cyano groups or 4 cyano groups. While there are many suitable crosslinkers the reactive mixture is free of an aziridine crosslinker. If present, the crosslinkers can function link different thermoplastic polyurethane chains of base layer 14 (e.g., intermolecular crosslink). Alternatively, the crosslinkers can function to crosslink different sections of the thermoplastic polyurethane chains (e.g., intramolecular crosslinks).

Surfacing film 10 can be applied to many suitable substrates. Moreover surfacing film 10 can be cut to precisely match the dimensions of any desired substrate. The substrate, as an example, can be a vehicle body, a window, or a portion thereof. With respect to a car, for example, surfacing film 10 can be sized to precisely fit a portion of a hood for a specific make and model of an automobile. In addition to a hood, surfacing film 10 can be cut to conform to other features of an automobile such as a fender, a mirror, a door, a roof, a panel, a portion thereof.

Surfacing film 10 can also be sized to precisely fit a portion of a water vessel such as a hull (e.g., to protect the hull during beaching), a transom (e.g., to protect the transom from damage caused by water skis), or a bulwark (e.g., to prevent damage caused by lines). Additionally, surfacing film 10 can be applied to trains or even aerospace vehicles such as an airplane or helicopter. For example, surfacing film 10 can be applied to a blade such as a propeller blade (e.g., to protect against debris strikes such as ice), an airfoil (e.g., a wing or a helicopter blade), or a fuselage.

According to various examples, a method of making surfacing film 10 can include forming base layer 14. Base layer 14 can be formed from a reactive mixture prepared in an extruder. Examples of suitable extruders include a twin-screw extruder or a planetary extruder. Suitable twin-screw extruders include a co-rotating-twin-screw extruder or a counter-rotating-twin-screw extruder. The components of the reactive mixture (e.g., the diisocyanate, diol chain extender, and polyester polyol) can be individually or simultaneously fed into the extruder. The method is free of introducing a pellet comprising a thermoplastic polyurethane into the extruder. Thus, the reactive mixture is free of any components necessary for pelletization such as wax processing aids, or an antisticking agent. The provided methods can help to ensure that the thermoplastic polyurethane film has a weight-average molecular weight of at least 80,000 daltons. This is because pellets introduced into an extruder can be subjected to significant shear, which can shorten the thermoplastic polyurethane chains and thus reduce the weight-average molecular weight of the resulting film.

Through extrusion, base layer 14 comprising a molten thermoplastic polyurethane is formed and extruded through a die onto a carrier web as a uniform film. An example of a suitable die includes a coat hanger die. The uniform film can be further pressed by a cold roller which thermally quenches the reaction shaping the polyurethane, thereby solidifying the thermoplastic polyurethane to obtain base layer 14.

The extrusion can occur at any suitable temperature. For example, the temperature can be in a range of from about 40° C. to about 230° C., about 90° C. to about 200° C., or less than, equal to, or greater than about 40° C., 45, 50, 55, 60, 65, 70, 75, 80, 85, 90, 95, 100, 105, or 110, 115, 120, 125, 130, 135, 140, 145, 150, 155, 160, 165, 170, 175, 180, 185, 190, 195, 200, 205, 210, 215, 220, 225, or 230° C. The extrusion can occur for any suitable amount of time. For example, the extrusion can occur for a period of time ranging from about 0.5 hours to about 17 hours, about 1 hour to about 6 hours, or less than, equal to, or greater than about 0.5 hours, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, or 17 hours.

To apply pressure-sensitive adhesive layer 16 to base layer 14 it can be desirable to corona treat (e.g., air or N₂ corona treatment) and thermally laminate a major surface of the extruded base layer 14 to be bonded to pressure-sensitive adhesive layer 16. To accomplish this, the major surface of base layer 14, which is not in contact with the clear coat layer 12, is exposed and then corona treated. If a hot laminating process is used (e.g., clear coat layer 12 is extruded onto a releasable carrier web or liner), the carrier web or liner can need to be first stripped off of clear coat layer 12.

Base layer 14 and clear coat layer 12 can be bonded together, for example by laminating the layers at an elevated temperature and pressure. For example, one major surface of the clear coat layer 12 can be cold laminated under pressure to one major surface of the extruded base layer 14, while at least the one major surface of the base layer 14 is, or both base layer 14 and the clear coat layer 12 are, at an elevated temperature that is sufficiently high enough to facilitate adequate bonding between clear coat layer 12 and base layer 14. As used herein, cold laminating refers to the layers being laminated together between two nip surfaces in about a room or ambient temperature environment (e.g., the layers are not kept in an intentionally heated environment during the laminating process). The nip surfaces can be two nip rollers, a stationary nip surface (e.g., a low friction surface of a flat or curved plate) and a nip roller, or two stationary nip surfaces. The laminating process can even be performed in a below ambient temperature environment (that is, the layers are intentionally cooled during the laminating process). For example, one or both of the nip surfaces can be chilled to a temperature below ambient, in order to cool the exposed major surfaces of the polyurethane layers (that is, the major surfaces the nip surfaces contact). The use of such chilled surfaces can eliminate, or at least help reduce, warping of the layers resulting from the laminating process. At the same time, the major surfaces that make contact at the interface between the polyurethane layers remain at the elevated temperature long enough to be sufficiently bonded together by the laminating pressure exerted by the nip surfaces. Such cold laminating can be accomplished by laminating the newly extruded base layer 14 directly onto a preformed clear coat layer 12, while the base layer 14 material still retains significant heat from the extrusion process. Clear coat layer 12 can be still releasably bonded to the carrier web or liner, to provide additional structural strength.

Alternatively, one major surface of clear coat layer 12 can also be bonded to one major surface of the extruded base layer 14 by using a hot laminating process. With this process, the initial temperature of both clear coat layer 12 and base layer 14 is about room temperature or at least a temperature that is too low to facilitate adequate bonding between clear coat layer 12 and base layer 14. Then, at least the one major surface of base layer 14, at least the one major surface of clear coat layer 12, or the one major surfaces of both clear coat layer 12 and base layer 14 are heated to an elevated temperature that is sufficiently higher than room temperature to facilitate adequate bonding between the clear coat layer 12 and base layer 14 under the laminating pressure. With the hot laminating process, the layers are heated before or during the application of the laminating pressure. If a hot laminating process is used, a major surface of base layer 14 can be releasably laminated to a readily releasable carrier web or liner (for example, a polyester carrier web) directly after base layer 14 is extruded, in order to provide the freshly base layer 14 with additional structural support.

Acceptable minimum temperatures and pressures for bonding the layers together, using either the cold or hot laminating process, have included a temperature of at least about 200° F. (93° C.) and a pressure of at least about 15 lb/in² or psi (10.3 N/cm²).

In another embodiment, the clear coat can be provided by an organic solvent-based coating composition, also referred to as a hardcoat. The hardcoat layer 17 can improve the stiffness, dimensional stability, and durability. The hardcoat layer 17 can also improve the adhesion between a siliceous layer 13 and base layer 14. In favored embodiments, the hardcoat layer (e.g. having a thickness of 2-10 microns (e.g. 5 microns) can be stretched 25, 50, or 75% at a rate of about 2 cm/second and maintained in the stretched condition for 1 hour without cracking.

In some embodiments, the hardcoat layer comprises one or more polymerized urethane (meth)acrylate oligomer(s). Typically, the urethane (meth)acrylate oligomer is a di(meth)acrylate. The term “(meth)acrylate” is used to designate esters of acrylic and methacrylic acids.

One suitable urethane (meth)acrylate oligomer that can be employed in the hardcoat composition is available from Sartomer Company (Exton, Pa.) under the trade designation “CN991”

Other suitable urethane (meth)acrylate oligomers are available from Sartomer Company under the trade designations “CN9001” and “CN981B88”. CN981B88″ is an aliphatic urethane (meth)acrylate oligomer available from Sartomer Company under the trade designation CN981 blended with SR238 (1,6 hexanediol diacrylate). The physical properties of these aliphatic urethane (meth)acrylate oligomers, as reported by the supplier, are set forth as follows:

| | Viscosity | Ultimate | Elongation | Tg (° C.) as |
|---|---|---|---|---|
| Trade | Cps at | Tensile | at | determined |
| Designation | 60° C. | Strength* | Break* | by DSC* |
| CN981 | 6190 | 1113 psi | 81 | 22 |
| | | (7.7 MPa) | | |
| CN981B88 | 1520 | 1520 psi | 41 | 28 |
| | | (10.5 MPa) | | |
| CN9001 | 46,500 | 3295 psi | 143 | 60 |
| | | (22.7 MPa) | | |
| CN991 | 660 | 5,378 psi | 79 | 27 |
| | | (37.1 MPa) | | |

*as reported by supplier

The reported tensile strength, elongation, and glass transition temperature (Tg) properties are based on a homopolymer prepared from such urethane (meth)acrylate oligomer.

Suitable urethane (meth)acrylate oligomers of the hardcoat can be characterized as having an elongation at break of at least 25% and typically no greater than 150% or 200%; a Tg ranging from about 0 to 30, 40, 50, 60 or 70° C.; and a tensile strength of at least 1,000 psi (6.9 MPa), or at least 5,000 psi (34.5 MPa). In some embodiments, the elongation at break of the urethane (meth)acrylate oligomer or hardcoat composition is at least 30, 35, 40, 45, 50, 55, 60, 65, 70, or 75%.

The molecular weight of the urethane (meth)acrylate oligomer(s) typically ranges from 800 to 5000 g/mole; as can be determined by gel permeation chromatography (GPC) utilizing polystyrene standards. In some embodiments, the molecular weight of the urethane (meth)acrylate oligomer(s) is no greater than 4500, 4000, or 3500 g/mole.

These embodied urethane (meth)acrylate oligomers and other urethane (meth)acrylate oligomers having similar physical properties can usefully be employed at concentration of at least 40 or 50 wt. % ranging up to 100 wt. % based on wt. % solids of the organic component of the hardcoat composition. In some embodiments, the concentration of polymerized urethane (meth)acrylate oligomers is at least 45, 50, 55, 60, 65, 70, 75, 80, 85, 90, or 95 wt. % solids of the organic components of the hardcoat composition.

In some embodiments, the urethane (meth)acrylate oligomer is combined with at least one multi(meth)acrylate monomer comprising at least two (meth)acrylate groups. The multi(meth)acrylate monomer generally has a lower molecular weight than the urethane (meth)acrylate oligomer and thereby increases the crosslinking density, as well as increases adhesion to the organic polymeric film and siliceous layer.

Suitable di(meth)acrylate monomers monomers include for example 1,3-butylene glycol diacrylate, 1,4-butanediol diacrylate, 1,6-hexanediol di (meth)acrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate. In some embodiments, the urethane (meth)acrylate oligomer may be purchased preblended with a di(meth)acrylate monomer such as in the case of CN988B88″.

In some embodiments, the amount of di(meth)acrylate monomer is at least 5, 10, 15, 20, 25, 30, 35, 40, 45, 50, 55 or 60 wt. % solids of the organic components of the hardcoat composition.

Substantial concentrations of (meth)acrylate monomer having greater than two (meth)acrylate groups can reduce the flexibility of the hardcoat layer. Hence, when such monomers are employed, the concentration is typically no greater than 10, 9, 8, 7, 6, 5, 4, 3, 2, or 1 wt.-% solids of the total hardcoat composition. In some embodiments, the hardcoat composition is free of monomers comprising more than two (meth)acrylate groups.

In typical embodiments, the hardcoat layer comprises polymerized units of at least one (e.g. non-polar) high Tg monomer, i.e. a (meth)acrylate monomer when reacted to form a homopolymer has a Tg greater than 25° C. The high Tg monomer more typically has a Tg greater than 30° C., 40° C., 50° C., 60° C., 70° C., or 80° C. The (e.g. non-polar) high Tg monomer typically has a Tg no greater than. Mixtures of high Tg monomer may be employed. In some embodiments, the mixture of monomers has a Tg ranging from about 50 to 75° C. In one embodiment, a mixture of hexanediol diacrylate and isobornyl acrylate is utilized.

In some embodiments, the hardcoat layer further comprises polymerized units of an ethylenically unsaturated compound that comprises siloxane or silyl groups, such as a silicone (meth)acrylate additive. Silicone (meth)acrylate additives generally comprise a polydimethylsiloxane (PDMS) backbone and a terminal (meth)acrylate group. In some embodiments, the silicone (meth)acrylate additive further comprises an alkoxy side chain. Such silicone (meth)acrylate additives are commercially available from various suppliers such as Tego Chemie under the trade designations “TEGO Rad 2100”, “TEGO Rad 2250”, “TEGO Rad 2300”, “TEGO Rad 2500”, and “TEGO Rad 2700”.

Based on NMR analysis “TEGO Rad 2100” is believed to have the following chemical structure:

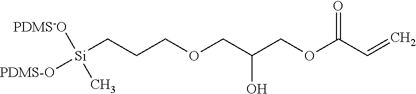

The PDMS backbone in combination with the OSi(CH₃)₃ group is believed to constitute about 50 wt-% of this silicone (meth)acrylate additive; whereas the alkoxy (meth)acrylate side chain is believed to constitute the remaining 50 wt-%.

The silicone (meth)acrylate additive is typically added to the hardcoat composition at a concentration of at least about 0.10, 0.20, 0.30, 0.40, or 0.50 wt. % solids of the organic component of the hardcoat composition to as much as 5 wt. %, 10 wt. % or 20 wt. % solids.

When such silicone (meth)acrylate additives are present on an exposed surface, such additives can reduce the tendency of lint to be attracted to the surface, as described in WO2009/029438. However, when such silicone (meth)acrylate additive are present in a hardcoat layer disposed between an organic polymeric film and (e.g. diamond-like glass) siliceous layer, it is surmised that the silicone or silyl group improves bonding with the siliceous layer.

In some embodiments, the hardcoat comprises a photoinitiator. Examples include chlorotriazines, benzoin, benzoin alkyl ethers, di-ketones, phenones, and the like. Commercially available photoinitiators include those available commercially from Ciba Geigy under the trade designations Daracur™ 1173, Darocur™ 4265, Irgacure™ 651, Irgacure™ 184, Irgacure™ 1800, Irgacure™ 369, Irgacure™ 1700, Irgacure™ 907, Irgacure™ 819 and from Aceto Corp. (Lake Success, N.Y.) under the trade designations UVI-6976 and UVI-6992. Phenyl-[p-(2-hydroxytetradecyloxy)phenyl]iodonium hexafluoroantomonate is a photoinitiator commercially available from Gelest (Tullytown, Pa.). Phosphine oxide derivatives include Lucirin™ TPO, which is 2,4,6-trimethylbenzoy diphenyl phosphine oxide, available from BASF (Charlotte, N.C). A difunctional alpha hydroxylketone photoiniators is commercially available from Lambertis USA under the trade designation “ESACURE ONE”. Other useful photoinitiators are known in the art. A photoinitiator can be used at a concentration of about 0.1 to 10 weight percent or about 0.1 to 5 weight percent based on the organic portion of the formulation (phr).

The hardcoat layer can be cured in an inert atmosphere. In some embodiments, the hardcoat layer can be cured with an ultraviolet (UV) light source under a nitrogen blanket.

The polymerizable hardcoat compositions can be formed by dissolving the free-radically polymerizable material(s) in a compatible organic solvent and then combined with the nanoparticle dispersion at a concentration of about 50 to 70 percent solids. A single or blend of the previously described organic solvent solvents can be employed.

The hardcoat composition can be applied as single or multiple layers to a (e.g. film) substrate using conventional film application techniques. Thin films can be applied using a variety of techniques, including dip coating, forward and reverse roll coating, wire wound rod coating, and die coating. Die coaters include knife coaters, slot coaters, slide coaters, fluid bearing coaters, slide curtain coaters, drop die curtain coaters, and extrusion coaters among others. Many types of die coaters are described in the literature. Although it is usually convenient for the substrate to be in the form of a roll of continuous web, the coatings may be applied to individual sheets.

The hardcoat composition is dried in an oven to remove the solvent and then cured for example by exposure to ultraviolet radiation using an H-bulb or other lamp at a desired wavelength, preferably in an inert atmosphere (less than 50 parts per million oxygen). The reaction mechanism causes the free-radically polymerizable materials to crosslink.

The thickness of the cured hardcoat layer 17 is typically at least 0.5 microns, 1 micron, or 2 microns. The thickness of the hardcoat layer is generally no greater than 10 microns.

In some embodiments, a major surface of thermoplastic polyurethane base layer 14 comprises a siliceous layer 13 on thermoplastic polyurethane base layer 14. In typical embodiments, hardcoat layer 17 is disposed between thermoplastic polyurethane base layer 14 and siliceous layer 13, as depicted in FIG. 4.

The siliceous layer is generally a continuous layer having a low level of porosity. For example, when a siliceous layer comprises a dried network of acid-sintered nanoparticles as described in WO2012/173803, the siliceous layer of sintered nanoparticles has a porosity of 20 to 50 volume percent, 25 to 45 volume percent, or 30 to 40 volume percent. Porosity may be calculated from the refractive index of the (sintered nanoparticle) primer layer coating according to published procedures such as in W. L. Bragg and A. B. Pippard, Acta Crystallographica, 6, 865 (1953). In contrast the siliceous layer described herein has a porosity less than 20, 15 or 10 volume percent. In some embodiments, the siliceous layer has a porosity of less than 9, 8, 7, 6, 5, 4, 3, 2, or 1 percent.

Fused silica is reported to have a refractive index of 1.458. Since air has a refractive index of 1.0, a porous siliceous layer has a lower refractive index than fused silica. For example, when the siliceous layer has a porosity of 20 volume percent, the calculated refractive index would be 1.164.

In some embodiments, siliceous layer further comprises carbon. For example, the siliceous layer may contain from about 10 to about 50 atomic percent carbon. Due to the inclusion of the carbon in combination with the low porosity, the siliceous layer can have a refractive index greater than 1.458 (i.e. fused silica). For example, the refractive index of the siliceous layer can be at least 1.48, 1.49, 1.50, 1.51, 1.52, 1.53, 1.54, 1.55, 1.56, 1.57, 1.58, 1.59, or 1.60. As the carbon content increase from 30 to 50 atomic percent carbon the refractive index also increases. In some embodiments, the refractive index can range up to 2.2.

The atomic composition (e.g. silicon, carbon, oxygen) of the siliceous layer can be determined by Electron Spectroscopy for Chemical Analysis (ESCA). The presence of Si—C bonding can be determined by Fourier Transform Infrared Spectroscopy (FTIR). Optical properties, such as refractive index, can be determined by Ellipsometry.

In one favored embodiment, the siliceous layer is a diamond-like glass (“DLG”) film, such as described in U.S. Pat. No. 6,696,157 (David et al.). An advantage of such material is that in addition to providing the siloxane-bondable front surface on the body member, such DLG can also provide improved stiffness, dimensional stability, and durability. This is particularly helpful when the underlying components of the base member may be relatively softer.

Illustrative diamond-like glass materials suitable for use herein comprise a carbon-rich diamond-like amorphous covalent system containing carbon, silicon, hydrogen and oxygen. The absence of crystallinity of the amorphous siliceous (e.g. DLG) layer can be determined by X-Ray Diffraction (XRD). The DLG is created by depositing a dense random covalent system comprising carbon, silicon, hydrogen, and oxygen under ion bombardment conditions by locating a substrate on a powered electrode in a radio frequency (“RF”) chemical reactor. In specific implementations, DLG is deposited under intense ion bombardment conditions from mixtures of tetramethylsilane and oxygen. Typically, DLG shows negligible optical absorption in the visible and ultraviolet regions, i.e., about 250 to about 800 nm. Also, DLG usually shows improved resistance to flex-cracking compared to some other types of carbonaceous films and excellent adhesion to many substrates, including ceramics, glass, metals and polymers.

DLG typically contains at least about 30 atomic percent carbon, at least about 25 atomic percent silicon, and less than or equal to about 45 atomic percent oxygen. DLG typically contains from about 30 to about 50 atomic percent carbon. In specific implementations, DLG can include about 25 to about 35 atomic percent silicon. Also, in certain implementations, the DLG includes about 20 to about 40 atomic percent oxygen. In specific advantageous implementations the DLG comprises from about 30 to about 36 atomic percent carbon, from about 26 to about 32 atomic percent silicon, and from about 35 to about 41 atomic percent oxygen on a hydrogen free basis. “Hydrogen free basis” refers to the atomic composition of a material as established by a method such as Electron Spectroscopy for Chemical Analysis (ESCA), which does not detect hydrogen even if large amounts are present in the thin films.

The (e.g. DLG) siliceous layer can made to a specific thickness, typically ranging from at least 50, 75 or 100 nm up to 10 microns. In some embodiments, the thickness is no greater than 5, 4, 3, 2, or 1 micron. In some embodiments, the thickness is less than 1 micron, 900 nm, 800 nm, 700 nm, 600 nm, 500 nm, 400 nm, 300 nm, or 200 nm.

The urethane (meth)acrylate oligomer and hardcoat composition is synthesized or selected such that it does not detract from the ability to stretch the film by hand. Thus, the conformable base layer 14 further comprising the hardcoat layer has a load at 25% strain/cm film width in the same range as previously described. In some embodiments, the load at 25% strain/cm film width is equal to or less than the load at 25% strain/cm film width of the (e.g. conformable) film alone. The inclusion of the siliceous (e.g. DLG) layer also does not detract from the load at 25% strain/cm film width. Thus, the conformable organic base member (e.g. film) further comprising the hardcoat layer and siliceous (e.g. DLG layer) also has a load at 25% strain/cm film width in the same range as previously described.

The inclusion of the hardcoat layer and DLG can affect the tensile modulus and ultimate tensile strength of the (e.g. conformable) film. These properties can change by 5, 10, 15 or 20 MPa, yet still fall within the ranges previously described.

In some embodiments, the inclusion of the hardcoat layer and siliceous layer (e.g. DLG) does not detract from the tensile strain at break or in other words elongation at break of the (e.g. conformable) film. Thus, the tensile stain at break of the film further comprising these layers is in the same range as previously described.

### EXAMPLES

Various embodiments of the present invention can be better understood by reference to the following Examples which are offered by way of illustration. The present invention is not limited to the Examples given herein.

### EXAMPLES

### Materials

TABLE 2

| Designation | Description | Supplier |
|---|---|---|
| FOMREZ-44-111 | Polyester polyol | Chemtura, |
| | | Philadelphia, PA |
| IRGANOX 1076 | Antioxidant, Octadecyl-3- | BASF, |
| | (3,5-di-tert•butyl-4- | Ludwigshafen, |
| | hydroxyphenyl)-propionate | Germany |
| 1,4 Butanediol | Chain extender diol | BASF |
| TINUVIN-292 | Hindered amine | BASF |
| TINUVIN-571 | UV light stabilizer | BASF |
| T12 | Dibutyl tin dilaurate | Air Products, |
| | catalyst | Detroit, MI |
| DESMODUR W | Bis(4-isocyantocyclohexyl) | Bayer, Leverkusen, |
| | methane | Germany |
| Glycerol | Crosslinker | Sigma-Aldrich, |
| | | St. Louis, MO |
| ESTANE | Caprolactone polyol based | Lubrizol, |
| | thermoplastic polyurethane | Wickliffe, OH |
| | resin pellet made from batch | |
| | reactor process followed by | |
| | granulizing and underwater | |
| | pelletizing | |
| ESTANE ALR | Caprolactone based thermo- | Lubrizol |
| CL87A-V | plastic polyurethane resin | |
| | pellet | |
| ESTANE D91 | Caprolactone polyol based | Lubrizol |
| F87MI | thermoplastic polyurethane | |
| | resin pellet made from a | |
| | continuous process followed | |
| | by underwater pelletizing | |

### Test Methods

### Gel Permeation Chromatography (GPC) Molecular Weight Measurement

Film samples were analyzed by conventional GPC against polystyrene molecular weight standards using tetrahydrofuran (THF) as solvent and eluent. Molecular weight results were not absolute but were relative to the hydrodynamic volume of polystyrene in THF. Thermoplastic polyurethane (“TPU”) resin sample solutions of concentration 2 mg/mL were prepared in tetrahydrofuran (THF, stabilized with 250 ppm of butylated hydroxytoluene). The samples were allowed to dissolve for approximately 3 hours. The sample solutions were filtered through 0.45 micrometer polytetrafluoroethylene syringe filters and then analyzed by gas phase chromatography.

### Gpc Conditions:

| | |
|---|---|
| Column set | 2 mm × 300 mm × 7.5 mm POLYPORE columns |
| | with guard |
| Col Heater | 40° C. |
| Eluent | THF at 1.0 mL/min |
| Injection | 100 microliters |
| Detector | Differential refractive index |

The measured weight average molecular weight (“MW_{W}”) was reported.

### Dynamic Mechanical Analysis

The dynamic mechanical properties were measured by using a Rheometrics Solids Analyzer (RSA) from TA Instruments, New Castle, Del. The temperature was monitored between −50° C. and 180° C. at 0.1% strain and 1.0 Hz. Glass transition temperature (“Tg”, obtained from the peak of Tan delta) and softening temperature were reported.

### 10% Bitumen in Diesel Fluid Staining

Standard bitumen was dissolved in diesel fluid to produce 10 wt % bitumen solution. Film was applied on a white painted panel (steel panel with 648DM640 basecoat and RK8014 clear coat, from ACT Test Panels, Hillsdale, Mich.). The 10 wt % bitumen solution was then applied on the surface of the film at about 1 inch (2.5 cm) diameter and left on the film surface for 24 hours. After 24 hours, it was cleaned using naphtha. The yellowing color change (“Δb”) of film surface before and after stained was measured by a standard colorimeter.

### Haze Value

For haze values, the thermoplastic polyurethane film sample was laminated to a transfer adhesive (isooctyl acrylate/acrylic acid copolymer) and applied onto a 6 mil (150 micrometer) layer of polyester terephthalate (PET) film. The initial haze was measured by a HAZEGARD and initial film haze was reported. Additionally, in some instances the film sample was heat aged for 7 days at 80° C., and then the haze was measured, again with a HAZEGARD and reported as “Haze after 7 days heat aging at 80° C.”.

In the following Examples (EX-1 to EX-3), the twin screw extruded aliphatic thermoplastic polyurethane films (TPF's) had hard segment content maintained at about 48.25 wt %, and a Shore A hardness maintained at about 87 A. Shore A hardness was measured according to ASTM standard D2240-15

### Example 1 (EX-1)

All the ingredients including 504.7 grams of pre-melted FOMREZ-44-111 (having a melting temperature of 60° C.) at 100° C., 5 grams of IRGANOX-1076, 0.3 grams of T12 dibutyltin dilaurate catalyst, 88.6 grams of 1,4 butanediol, 393.9 grams of DESMODUR W, 3 grams of TINUVIN-292, and 4.5 grams of TINUVIN-571 were fed separately into a twin-screw extruder. The extruder setup, conditions, and temperature profiles were similar to that described in Example No. 1 and in Table 1 in U.S. Pat. No. 8,551,285. The isocyanate index was NCO/OH=1.01 and hard segment was at 48.25 wt %. The resulting aliphatic thermoplastic polyurethane film (TPF) was extruded as a 150 micrometers thick layer onto a polyester carrier web. The TPF was aged 2 weeks at ambient temperature before testing, with test results as summarized in Table 3.

### Example 2 (EX-2)

All the ingredients including 505.2 grams of pre-melted FOMREZ-44-111 (having a melting temperature of 60° C.) at 100° C., 5 grams of IRGANOX-1076, 0.3 grams of T12 dibutyltin dilaurate catalyst, 85.7 grams of 1,4 butanediol, 397.2 grams of DESMODUR W, 3 grams of TINUVIN-292, and 4.5 grams of TINUVIN-571 were fed separately into the twin screw extruder. The extruder setup, conditions, and temperature profiles were similar to that described in Example No. 1 and in Table 1 in U.S. Pat. No. 8,551,285. The isocyanate index was NCO/OH=1.04 and hard segment content was 48.25%. The resulting aliphatic thermoplastic polyurethane film (TPF) was extruded as a 150 micrometers thick layer onto a polyester carrier web. The TPF was aged 2 weeks at ambient temperature before testing, with test results as summarized in Table 3.

### Example 3 (EX-3)

All the ingredients including 509.7 grams of pre-melted FOMREZ-44-111 (having a melting temperature of 60° C.) at 100° C., 5 grams of IRGANOX-1076, 1.0 grams of T12 dibutyltin dilaurate catalyst, 87.1 grams of 1,4 butanediol, 0.9 grams of glycerol, 394.5 grams of DESMODUR W, 3 grams of TINUVIN-292, and 4.5 grams of TINUVIN-571 were fed separately into the twin-screw extruder. The extruder setup, conditions, and temperature profiles were similar to that described in Example No. 1 and in Table 1 in U.S. Pat. No. 8,551,285. The isocyanate index was NCO/OH=1.01 and hard segment was at 48.25%. The hydroxyl group crosslinker was 1.0% based on the total hydroxyl mole %. The resulting aliphatic thermoplastic polyurethane film (TPF) was extruded as a 150 micrometers thick layer onto a polyester carrier web. The TPF was aged 2 weeks at ambient temperature before testing, with test results as summarized in Table 3.

### Comparative Example 1 (CE-1)

Thermoplastic polyurethane resin pellet ESTANE D91F87MI was produced by twin screw reactive extrusion process followed by pelletization of the resin in underwater bath. The TPU pellet, which comprised processing wax and anti-sticking agents, was extruded as a 150 micrometers thick film onto a polyester carrier web, by the same twin screw extruder at similar extrusion temperature profiles as in Example 1. The TPF was aged 2 weeks at ambient temperature before testing, with test results as summarized in Table 3.

### Comparative Example 2 (CE-2)

Thermoplastic polyurethane resin pellet ESTANE ALR CL87A-V, which comprised processing wax and anti-sticking agent, was extruded as a 150 micrometers thick film onto a polyester carrier web, by the same twin screw extruder at similar extrusion temperature profiles as in Example 1. The TPF was aged 2 weeks at ambient temperature before testing, with test results as summarized in Table 3.

TABLE 3

| | | | | | Haze | |
|---|---|---|---|---|---|---|
| | | | | | after | |
| | | | | | 7 days | |
| | | | | Initial | heat | |
| | | Softening | Tg, | film | aging | |
| Sample | MW_{w} | temp., ° C. | ° C. | haze | at 80° C. | Δb |
| EX-1 | 98,300 | 110.8 | 28 | 0.79 | 1.03 | 9.82 |
| EX-2 | 249,000 | 128.0 | 30.4 | 0.78 | ND | 7.96 |
| EX-3 | 139,000 | 113.1 | 31.7 | 0.79 | ND | 8.36 |
| CE-1 | 58,300 | 99.1 | 16.5 | 1.78 | 8.10 | 14.3 |
| CE-2 | 81,000 | 98.7 | 24.3 | 1.20 | 2.20 | 12.48 |

In Table 3, “ND” = not determined

### Example 4

A hardcoat was prepared by combining the following components with MEK with stirring to produce a 35% solids solution:
65.2 wt. % CN991 (Aliphatic polyurethane diacrylate Tg=27° C., obtained from Sartomer Americas, Exton, Pa., USA),
16.4 wt. % SR506 (Isobornyl Acrylate, Tg=88° C., obtained from Sartomer Americas), and
16.4 wt. % SR238 (Hexanediol diacrylate, Tg=43° C., obtained from Sartomer Americas)
   97.3 wt. % of the solution was combined with 2 wt. % Esacure One photoinitator and 0.6 wt. % Tegorad 2100.

The hardcoat coating composition was applied to the thermoplastic polyurethane film of Example 3 using a #12 wire wound rod (available from R.D. Specialties, Webster N.Y.) and dried at 65° C. for 2 minutes. The coating was then cured using a 500 Watt/in Fusion H bulb (available from Fusion UV Systems, Gaithersburg Md.) at 100% power under nitrogen at 40 feet/minute (12.2 m/min). The cured coating had a thickness of about 5 microns.

### Example 5

A DLG layer was deposited onto the cured hardcoat layer of the film of Example 4 using a 2-step web process. A homebuilt plasma treatment system described in detail in U.S. Pat. No. 5,888,594 (David et al.) was used with some modifications: the width of the drum electrode was increased to 42.5 inches (108 cm) and the separation between the two compartments within the plasma system was removed so that all the pumping was carried out by means of the turbo-molecular pump and thus operating at a process pressure of around 10-50 mTorr (1.33-6.7 Pa).

A roll of the film with the cured hardcoat was mounted within the chamber, the film wrapping around the drum electrode and secured to the take up roll on the opposite side of the drum. The unwind and take-up tensions were maintained at 8 pounds (13.3 N) and 14 pounds (23.3 N) respectively. The chamber door was closed and the chamber was pumped down to a base pressure of 5×10⁻⁴ torr (6.7 Pa). For the deposition step, hexamethyldisiloxane (HMDSO) and oxygen were introduced at a flow rate of 200 standard cm³/min and 1000 standard cm³/min respectively, and the operating pressure was nominally at 35 mTorr (4.67 Pa). Plasma was turned on at a power of 9500 watts by applying rf power to the drum and the drum rotation initiated so that the film was transported at a speed of 10 feet/min (3 m/min). The run was continued until the entire length of the film on the roll was completed.

After the completion of the DLG deposition step, the rf power was disabled, the flow of HMDSO vapor was stopped, and the oxygen flow rate increased to 2000 standard cm³/min. Upon stabilization of the flow rate, and pressure, plasma was reinitiated at 4000 watts, and the web transported in the opposite direction at a speed of 10 ft/min (3 m/min), with the pressure stabilizing nominally at 14 mTorr (1.87 Pa). This second plasma treatment step was to remove the methyl groups from the DLG film, and to replace them with oxygen containing functionalities, such as Si—OH groups, which facilitated the grafting of the silane compounds to the DLG film.

After the entire roll of film was treated in the above manner, the rf power was disabled, oxygen flow stopped, chamber vented to the atmosphere, and the roll taken out of the plasma system for further processing. The thickness of resulting DLG layer was about 60 nm.

### Tensile Testing Test Method

Tensile specimens were cut from the film of Example 3, the film of Example 4 with the cured hardcoat, and the film of Example 5 with the cured hardcoat and DLG layer using a cutter to obtain 25 cm long×12.7 mm wide specimens. Tensile testing was done using an Instron model 55R1122 universal load frame with flat grips according to ASTM D882-12. For all samples, the initial grip spacing was 5.1 cm, and the crosshead speed was 100 mm/min. The temperature during testing was 20±2° C. The nominal film thickness was utilized to determine modulus and tensile strength, which neglected the adhesive thickness. All results are the average of 5 tested specimens.

TABLE 4
Tensile Test Results

| | | | | | | | Load |
|---|---|---|---|---|---|---|---|
| | | | | | | | @ 25% |
| | | | | | | | strain/ |
| | | | | Ultimate | Elon- | Load | mm |
| | | | Tensile | Tensile | gation | @ 25% | film |
| | Hard- | DLG | modulus | Strength | at break | strain | width |
| | coat | coating | (MPa) | (MPa) | (%) | (N) | (N/cm) |
| Ex. 3 | No | No | 80 | 24 | 240 | 8 | 6.3 |
| Ex. 4 | Yes | No | 55 | 34 | 330 | 6 | 4.7 |
| Ex. 5 | Yes | Yes | 91 | 20 | 240 | 6 | 4.7 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed can be resorted to by those of ordinary skill in the art, and that such modifications and variations are considered to be within the scope of embodiments of the present invention.

### ADDITIONAL EMBODIMENTS

The following exemplary embodiments are provided, the numbering of which is not to be construed as designating levels of importance:

Embodiment 1 provides a surfacing film comprising:

a base layer comprising:

a thermoplastic polyurethane film comprising a reaction product of a reaction mixture comprising:
a diisocyanate; and
a polyester polyol having a melting temperature of at least 30° C.; and
a diol chain extender.

Embodiment 2 provides the surfacing film of Embodiment 1, wherein a weight-average molecular weight of the thermoplastic polyurethane film is in a range of from about 80,000 daltons to about 400,000 daltons.

Embodiment 3 provides the surfacing film of any one of Embodiments 1 or 2, wherein a melting temperature of the polyester polyol is at least 40° C.

Embodiment 4 provides the surfacing film of any one of Embodiments 1-3, wherein the diisocyanate has the structure:

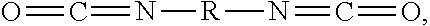

wherein R is chosen from substituted or unsubstituted (C₁-C₄₀)alkylene, (C₂-C₄₀)alkylene, (C₂-C₄₀)alkenylene, (C₄-C₂₀)arylene, (C₄-C₂₀)arylene-(C₁-C₄₀)alkylene-(C₄-C₂₀)arylene, (C₄-C₂₀)cycloalkylene, and (C₄-C₂₀)aralkylene.

Embodiment 5 provides the surfacing film of any one of Embodiments 1-4, wherein the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, or a mixture thereof.

Embodiment 6 provides the surfacing film of any one of Embodiments 1-5, wherein the polyester polyol is a product of a condensation reaction.

Embodiment 7 provides the surfacing film of any one of Embodiments 1-6, wherein the polyester polyol is free of ring opening polymerization reaction products.

Embodiment 8 provides the surfacing film of any one of Embodiments 1-7, wherein the polyester polyol is a polyester diol.

Embodiment 9 provides the surfacing film of any one of Embodiments 1-8, wherein the polyester polyol comprises one or more of polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, and copolymers thereof.

Embodiment 10 provides the surfacing film of any one of Embodiments 6-9, wherein the condensation reaction comprises a reaction between at least one of:

a plurality of carboxylic acids; and

a carboxylic acid and a polyol.

Embodiment 11 provides the surfacing film of Embodiment 10, wherein the carboxylic acid has the structure:

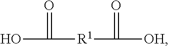

wherein R¹ is chosen from substituted or unsubstituted (C₁-C₄₀)alkylene, (C₂-C₄₀)alkylene, (C₂-C₄₀)alkenylene, (C₄-C₂₀)arylene, (C₄-C₂₀)cycloalkylene, and (C₄-C₂₀)aralkylene.

Embodiment 12 provides the surfacing film of any one of Embodiments 10 or 11, wherein the carboxylic acid is chosen from glycolic acid, lactic acid, succinic acid, 3-hydoxybutanoic acid, 3-hydroxypentanoic acid, terepthalic acid, naphthalene dicarboxylic acid, 4-hydroxybenzoic acid, 6-hydroxynaphtalane-2-carboxylic acid, oxalic acid, malonic acid, adipic acid, pimelic acid, ethonic acid, suberic acid, azelaic acid, sebacic acid, glutaric acid, dedecandioic acid, brassylic acid, thapsic acid, maleic acid, fumaric acid, glutaconic acid, 2-decenedioic acid, traumatic acid, muconic acid, glutinic acid, citraconic acid, mesaconic acid, itaconic acid, malic acid, aspartic acid, glutamic acid, tartonic acid, tartaric acid, diaminopimelic acid, saccharic acid, mexooxalic acid, oxaloacetic acid, acetonedicarboxylic acid, arbinaric acid, phtalic acid, isophtalic acid, diphenic acid, 2,6-naphtalenedicarboxylic acid, or a mixture thereof.

Embodiment 13 provides the surfacing film of any one of Embodiments 10-12, wherein the polyol has the structure:

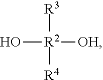

wherein R² is chosen from substituted or unsubstituted C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene, and R³ and R⁴ are independently chosen from —H, —OH, substituted or unsubstituted (C₁-C₄₀)alkyl, (C₂-C₄₀)alkenyl, (C₄-C₂₀)aryl, (C₁-C₂₀)acyl, (C₄-C₂₀)cycloalkyl, (C₄-C₂₀)aralkyl, and (C₁-C₄₀)alkoxy.

Embodiment 14 provides the surfacing film of any one of Embodiments 1-12, wherein polyester polyol has the structure:

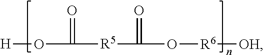

wherein R⁵ and R⁶ are independently chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene and n is a positive integer greater than or equal to 1.

Embodiment 15 provides the surfacing film of any one of Embodiments 1-12, wherein the polyester polyol has the structure:

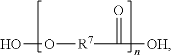

wherein R⁷ is chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene and n is a positive integer greater than or equal to 1.

Embodiment 16 provides the surfacing film of any one of Embodiments 1-15, wherein the diol chain extender is chosen from ethylene glycol, diethylene glycol, triethylene glycol, tetraethylene glycol, propylene glycol, dipropylene glycol, tripropylne glycol, 1,3-propanediol, 1,3-butanediol, 1,4-butanediol, neopentyl glycol, 1,6-hexanediol, 1,4-cyclohexanedimethanol, or a mixture thereof.

Embodiment 17 provides the surfacing film of any one of Embodiments 1-16, wherein the diol chain extender has a weight-average molecular weight of less than about 250 daltons.

Embodiment 18 provides the surfacing film of any one of Embodiments 1-17, wherein the thermoplastic polyurethane comprises a hard segment in a range of from about 30 wt % to about 55 wt %.

Embodiment 19 provides the surfacing film of any one of Embodiments 1-18, wherein the thermoplastic polyurethane film comprises a hard segment in a range of from about 40 wt % to about 55 wt %.

Embodiment 20 provides the surfacing film of any one of Embodiments 1-19, wherein the base layer is substantially free of at least one of a wax, an antisticking agent, and a processing aid.

Embodiment 21 provides the surfacing film of Embodiment 20, wherein a yellowing color change of the protection film exposed to a 10% bitumen solution for 24 hours is less than that of a corresponding protection film comprising a base layer that includes at least one of a wax, an anti-sticking agent, and a processing aid.

Embodiment 22 provides the surfacing film of any one of Embodiments 1-21, wherein the base layer is transparent.

Embodiment 23 provides the surfacing film of any one of Embodiments 1-22, wherein an initial film haze of the base layer is in a range of from 0.7 to about 1.0.

Embodiment 24 provides the surfacing film of any one of Embodiments 1-23, further comprising a clear coat layer attached to a second major surface of the base layer opposite the first major surface.

Embodiment 25 provides the surfacing film of Embodiment 24, wherein the clear coat layer comprises a thermosetting polyurethane.

Embodiment 26 provides the surfacing film of any one of Embodiments 1-25, wherein the polyurethane of the base layer is at least partially crosslinked.

Embodiment 27 provides the surfacing film of Embodiment 26, wherein the polyurethane is crosslinked with a hydroxyl crosslinker.

Embodiment 28 provides the surfacing film of any one of Embodiments 1-27, wherein the polyester polyol is free of polycaprolactone polyol.

Embodiment 29 provides the surfacing film, of any one of Embodiments 1-28, wherein the surfacing film is a surface protection film.

Embodiment 30 provides the surfacing film of any one of Embodiments 1-29, further comprising a pressure-sensitive adhesive layer disposed on a major surface of the base layer.

Embodiment 31 provides the surfacing film of any one of Embodiments 1-30, where a Shore A hardness of the base layer is in a range of from about 70 A to about 95 A.

Embodiment 32 provides the surfacing film of any one of Embodiments 1-31, where a Shore A hardness of the base layer is in a range of from about 83 A to about 90 A.

Embodiment 33 provides an assembly comprising the surfacing film of any one of Embodiments 1-32.

Embodiment 34 provides the assembly of Embodiment 33, further comprising a substrate chosen from a section of a vehicle body or a window, wherein the surfacing film is attached to the substrate.

Embodiment 35 provides the assembly of Embodiment 34, wherein the section of the vehicle is chosen from a hood, a fender, a mirror, a door, a roof, a panel, a portion thereof, a hull, a propeller, a blade, an airfoil, fuselage, or a combination thereof.

Embodiment 36 provides a method of forming the surfacing film of any one of Embodiments 1-35, the method comprising the steps of:

forming a base layer by a process comprising:
introducing components comprising a diisocyanate, a diol chain extender, and a polyester polyol into an extruder to provide a molten thermoplastic polyurethane, wherein the polyester polyol has a melting temperature of at least 30° C.;
extruding the molten thermoplastic polyurethane through a die onto a carrier web as a uniform film; and
solidifying the thermoplastic polyurethane film to obtain the base layer.

Embodiment 37 provides a method of making a surfacing film, the method comprising the steps of:

forming a base layer by a process comprising:
introducing components comprising a diisocyanate, a diol chain extender, and a polyester polyol into an extruder to provide a molten thermoplastic polyurethane, wherein the polyester polyol has a melting temperature of at least 30° C.;
extruding the molten thermoplastic polyurethane through a die onto a carrier web as a uniform film; and
solidifying the thermoplastic polyurethane film to obtain the base layer.

Embodiment 38 provides the method of Embodiment 37, further comprising laminating a pressure sensitive adhesive layer onto a first major surface of the base layer.

Embodiment 39 provides the method of Embodiment 38, further comprising laminating a clear coating comprising a thermosetting polyurethane onto a second major surface of the base layer.

Embodiment 40 provides the method of any one of Embodiments 37 or 39, wherein an isocyanate index of the components of the thermoplastic polyurethane is in a range of from about 0.99 to about 1.20.

Embodiment 41 provides the method of any one of Embodiments 37-40, wherein an isocyanate index of the components of the thermoplastic polyurethane is in a range of from about 1.00 to about 1.10.

Embodiment 42 provides the method of any one of Embodiments 37-41, wherein the extruder is a twin-screw extruder or a planetary extruder.

Embodiment 43 provides the method of Embodiment 42, wherein the twin-screw extruder is a co-rotating-twin-screw extruder or a counter-rotating-twin-screw extruder.

Embodiment 44 provides the method of any one of Embodiments 37-43, wherein a weight-average molecular weight of the polyurethane film is in a range of from about 80,000 daltons to about 400,000 daltons.

Embodiment 45 provides the method of any one of Embodiments 37-44, wherein a weight-average molecular weight of the polyurethane film is in a range of from about 100,000 daltons to about 250,000 daltons.

Embodiment 46 provides the method of any one of Embodiments 37-45, wherein the diisocyanate has the structure:

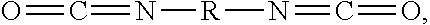

wherein R is chosen from substituted or unsubstituted (C₁-C₄₀)alkylene, (C₂-C₄₀)alkylene, (C₂-C₄₀)alkenylene, (C₄-C₂₀)arylene, (C₄-C₂₀)arylene-(C₁-C₄₀)alkylene-(C₄-C₂₀)arylene, (C₄-C₂₀)cycloalkylene, and (C₄-C₂₀)aralkylene.

Embodiment 47 provides the method of any one of Embodiments 37-46, wherein the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, isophorone diisocyanate, toluylene diisocyanate, diphenylmethane 4,4′-diisocyanate, 1,4-diisocyanatobutane, 1,8-diisocyanatooctane, or a mixture thereof.

Embodiment 48 provides the method of any one of Embodiments 37-47, wherein the polyester polyol is a product of a condensation reaction.

Embodiment 49 provides the method of any one of Embodiments 37-48, wherein the polyester polyol is free of ring opening polymerization reaction products.

Embodiment 50 provides the method of any one of Embodiments 37-49, wherein the polyester polyol is a polyester diol.

Embodiment 51 provides the method of any one of Embodiments 37-50, wherein the diol chain extender has a weight-average molecular weight of about 250 daltons.

Embodiment 52 provides the method of any one of Embodiments 37-51, wherein the polyester polyol comprises one or more of polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, and copolymers thereof.

Embodiment 53 provides the method of any one of Embodiments 48-52, wherein the condensation reaction comprises a reaction between at least one of:

a plurality of carboxylic acids; and

a carboxylic acid and a polyol.

Embodiment 54 provides the method of Embodiment 53, wherein the carboxylic acid has the structure:

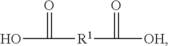

wherein R¹ is chosen from (C₁-C₄₀)alkylene, (C₂-C₄₀)alkylene, (C₂-C₄₀)alkenylene, (C₄-C₂₀)arylene, (C₄-C₂₀)cycloalkylene, and (C₄-C₂₀)aralkylene.

Embodiment 55 provides the method of any one of Embodiments 53 or 54, wherein the carboxylic acid is chosen from glycolic acid, lactic acid, succinic acid, 3-hydoxybutanoic acid, 3-hydroxypentanoic acid, terepthalic acid, naphthalene dicaboxylic acid 4-hydroxybenzoic acid, 6-hydroxynaphtalane-2-carboxylic acid, oxalic acid, malonic acid, adipic acid, pimelic acid, ethonic acid, subenic acid, azelaic acid, sebacic acid, glutaric acid, dedecandioic acid, brassylic acid, thapsic acid, maleic acid, fumaric acid, glutaconic acid, 2-decenedioic acid, traumatic acid, muconic acid, glutinic acid, citraconic acid, mesaconic acid, itaconic acid, malic acid, aspartic acid, glutamic acid, tartonic acid, tartaric acid, diaminopimelic acid, saccharic acid, mexooxalic acid, oxaloacetic acid, acetonedicarboxylic acid, arbinaric acid, phthalic acid, isophtalic acid, diphenic acid, 2,6-naphtalenedicarboxylic acid, or a mixture thereof.

Embodiment 56 provides the method of any one of Embodiments 53-55, wherein the polyol has the structure:

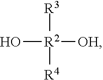

wherein R² is chosen from (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene, and R³ and R⁴ are independently chosen from —H, —OH, (C₁-C₄₀)alkyl, (C₂-C₄₀)alkenyl, (C₄-C₂₀)aryl, (C₁-C₂₀)acyl, (C₄-C₂₀)cycloalkyl, (C₄-C₄₀)aralkyl, and (C₁-C₄₀)alkoxy.

Embodiment 57 provides the method of any one of Embodiments 37-56, wherein polyester polyol has the structure:

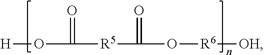

wherein R⁵ and R⁶ are independently chosen from substituted or unsubstituted (C₁-C₄₀)alkylene, (C₂-C₄₀)alkenylene, (C₄-C₂₀)arylene, (C₁-C₂₀)acylene, (C₄-C₂₀)cycloalkylene, (C₄-C₂₀)aralkylene, and (C₁-C₄₀)alkoxyene and n is a positive integer greater than or equal to 1.

Embodiment 58 provides the method of any one of Embodiments 37-57, wherein the polyester polyol has the structure:

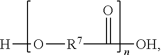

wherein R⁷ is chosen from substituted or unsubstituted (C₁-C₄₀)alkylene, (C₂-C₄₀)alkenylene, (C₄-C₂₀)arylene, (C₁-C₄₀)acylene, (C₄-C₂₀)cycloalkylene, (C₄-C₂₀)aralkylene, and (C₁-C₄₀)alkoxyene and n is a positive integer greater than or equal to 1.

Embodiment 59 provides the method of any one of Embodiments 37-58, wherein the diol chain extender is chosen from ethylene glycol, diethylene glycol, triethylene glycol, tetraethylene glycol, propylene glycol, dipropylene glycol, tripropylne glycol, 1,3-propanediol, 1,3-butanediol, 1,4-butanediol, neopentyl glycol, 1,6-hexanediol, 1,4-cyclohexanedimethanol, or a mixture thereof.

Embodiment 60 provides the method of any one of Embodiments 37-59, wherein the thermoplastic polyurethane film comprises a hard segment in a range of from about 30% to about 55%.

Embodiment 61 provides the method of any one of Embodiments 37-60, wherein the thermoplastic polyurethane film comprises a hard segment in a range of from about 40% to about 55%.

Embodiment 62 provides the method of any one of Embodiments 37-61, wherein the surfacing film is transparent.

Embodiment 63 provides the method of any one of Embodiments 37-62, further comprising a clear coat layer attached to a second major surface of the base layer opposite the first major surface.

Embodiment 64 provides the method of Embodiment 63, wherein the clear coat layer comprises a thermosetting polyurethane.

Embodiment 65 provides the method of any one of Embodiments 37-64, wherein the polyurethane film of the base layer is at least partially crosslinked.

Embodiment 66 provides the method, of any one of Embodiments 37-65, wherein the components comprises a hydroxyl crosslinker.

Embodiment 67 provides the method of any one of Embodiments 37-66, wherein the components are substantially free of an aziridine crosslinker.

Embodiment 68 provides a surfacing film formed according to the method of any one of Embodiments 37-68.

Embodiment 70 provides a method of using the surfacing film of any one of Embodiments 1-36, 68, or formed according to the method of any one of Embodiments 37-67, the method comprising:

contacting the surfacing film with a substrate.

Embodiment 71 provides the method of Embodiment 70, further comprising contacting the pressure surface adhesive of the body layer with the substrate.

Embodiment 72 provides the method of any one of Embodiment 70 or 71, wherein the substrate is selected from a section of a vehicle body or a window.

Embodiment 73 provides the method of Embodiment 72, wherein the section of the vehicle is chosen from a hood, a fender, a mirror, a door, a roof, a panel, a portion thereof, a hull, a propeller, a blade, an airfoil, fuselage, or a combination thereof.

Embodiment 73 provides the surfacing film of any one of Embodiments 1-31 wherein the surfacing film exhibits a load at 25% strain of no greater than 20 N/cm film width, as determined with tensile testing with a crosshead speed of 100 mm/min.

Embodiment 74 provides the surfacing film of any one of Embodiments 1-31 and 73 wherein the surfacing film exhibits an elongation at break of at least 150%, as determined with tensile testing utilizing a stain rate of 200%/min.

Embodiment 75 provides the surfacing film of any one of Embodiments 1-31 and 73-74 wherein the surfacing film further comprises a hardcoat layer that can be stretch 25-75% without cracking.

Embodiment 76 provides the surfacing film of any one of Embodiments 1-31 and 73-75 wherein the hardocat layer comprises a polymerized urethane (meth)acrylate oligomer present in an amount ranging from 40 to 100 wt.-% based on the wt.-% solids of the hardcoat.

Embodiment 77 provides the surfacing film of any one of Embodiments 1-31 and 73-76 wherein the hardcoat layer further comprises polymerized units of an ethylenically unsaturated monomer, wherein a homopolymer of the ethylenically unsaturated monomer has a glass transition temperature greater than 25, 30, 35, 40, 45, 50, 55, 60 or 65° C.

Embodiment 78 provides the surfacing film of any one of Embodiments 1-31 and 73-77 wherein the surfacing film further comprises a siliceous layer.

Embodiment 79 provides the surfacing film of any one of Embodiments 1-31 and 73-78 wherein the surfacing film comprises i) a hardcoat layer; or ii) a hardcoat layer and siliceous layer; and the surfacing film exhibits an elongation at break of at least 150%, as determined with tensile testing utilizing a stain rate of 200%/min.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A surfacing film comprising:
a base layer comprising:
a thermoplastic polyurethane film comprising a reaction product of a reaction mixture comprising:
a diisocyanate; and
a polyester polyol having a melting temperature of at least about 30° C.; and
a diol chain extender.

2. The surfacing film of claim 1, wherein a weight-average molecular weight of the thermoplastic polyurethane film is in a range of from about 80,000 daltons to about 400,000 daltons.

3. The surfacing film of claim 1, wherein the diisocyanate is chosen from dicyclohexylmethane-4,4′-diisocyanate, isophorone diisocyanate, hexamethylene diisocyanate, 1,4-phenylene diisocyanate, 1,3-phenylene diisocyanate, m-xylylene diisocyanate, tolylene-2,4-diisocyanate, toluene 2,4-diisocyanate, tolylene-2,6-diisocyanate, poly(hexamethylene diisocyanate), 1,4-cyclohexylene diisocyanate, 4-chloro-6-methyl-1,3-phenylene diisocyanate, hexamethylene diisocyanate, toluylene diisocyanate, diphenylmethane 4,4′-diisocyanate, 1,4-diisocyanatobutane, 1,8-diisocyanatooctane, or a mixture thereof.

4. The surfacing film of claim 1, wherein the polyester polyol is a product of a condensation reaction.

5. The surfacing film of claim 1, wherein the polyester polyol is a polyester diol.

6. The surfacing film of claim 1, wherein the polyester polyol comprises one or more of polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, and copolymers thereof.

7. The surfacing film of claim 4, wherein the condensation reaction comprises a reaction between at least one of:
a plurality of carboxylic acids; and
a carboxylic acid and a polyol.

8. The surfacing film of claim 7, wherein the carboxylic acid is chosen from glycolic acid, lactic acid, succinic acid, 3-hydoxybutanoic acid, 3-hydroxypentanoic acid, terepthalic acid, naphthalene dicarboxylic acid, 4-hydroxybenzoic acid, 6-hydroxynaphtalane-2-carboxylic acid, oxalic acid, malonic acid, adipic acid, pimelic acid, ethonic acid, suberic acid, azelaic acid, sebacic acid, glutaric acid, dedecandioic acid, brassylic acid, thapsic acid, maleic acid, fumaric acid, glutaconic acid, 2-decenedioic acid, traumatic acid, muconic acid, glutinic acid, citraconic acid, mesaconic acid, itaconic acid, malic acid, aspartic acid, glutamic acid, tartonic acid, tartaric acid, diaminopimelic acid, saccharic acid, mexooxalic acid, oxaloacetic acid, acetonedicarboxylic acid, arbinaric acid, phtalic acid, isophtalic acid, diphenic acid, 2,6-naphtalenedicarboxylic acid, or a mixture thereof.

9. The surfacing film of claim 1, wherein the diol chain extender is chosen from ethylene glycol, diethylene glycol, triethylene glycol, tetraethylene glycol, propylene glycol, dipropylene glycol, tripropylne glycol, 1,3-propanediol, 1,3-butanediol, 1,4-butanediol, neopentyl glycol, 1,6-hexanediol, 1,4-cyclohexanedimethanol, or a mixture thereof.

10. The surfacing film of claim 1, wherein the diol chain extender has a weight-average molecular weight of less than about 250 daltons.

11. The surfacing film of claim 1, wherein the thermoplastic polyurethane film comprises a hard segment in a range of from about 30 wt % to about 55 wt %.

12. The surfacing film of claim 1, where a Shore A hardness of the base layer is in a range of from about 70 A to about 95 A.

13. A method of making a surfacing film, the method comprising the steps of:
forming a base layer by a process comprising:
introducing components comprising a diisocyanate, a diol chain extender, and a polyester polyol into an extruder to provide a molten thermoplastic polyurethane, wherein the polyester polyol has a melting temperature of at least 30° C.;
extruding the molten thermoplastic polyurethane through a die onto a carrier web as a uniform film; and
solidifying the thermoplastic polyurethane film to obtain the base layer.

14. (canceled)

15. The method of claim 13, further comprising laminating a clear coating comprising a thermosetting polyurethane onto a second major surface of the base layer.

16. The method of claim 13, wherein an isocyanate index of the components of the thermoplastic polyurethane is in a range of from about 0.99 to about 1.20.

17. The method of claim 13, wherein the weight-average molecular weight of the thermoplastic polyurethane film is in a range of from about 80,000 daltons to about 400,000 daltons.

18. (canceled)

19. The method of claim 13, wherein the polyester polyol is a product of a condensation reaction.

20. The method of claim 13, wherein the polyester polyol comprises one or more of polyglycolic acid, polybutylene succinate, poly(3-hydroxybutyrate-co-3-hydroxyvalerate), polyethylene terephthalate, polybutylene terephthalate, polytrimethylene terephthalate, polyethylene naphthalate, poly(1,4-butylene adipate), poly(1,6-hexamethylene adipate), poly(ethylene-adipate), mixtures thereof, and copolymers thereof.

21-23. (canceled)

24. The surfacing film of claim 1 wherein the hardcoat layer comprises a polymerized urethane (meth)acrylate oligomer present in an amount ranging from 40 to 100 wt.-% based on the wt.-% solids of the hardcoat.

25. (canceled)

26. The surfacing film of claim 1 wherein the surfacing film further comprises a siliceous layer.

27. (canceled)
